(19) United States
(12) Patent Application Publication
(10) Pub. No.: US 2022/0407925 A1
(43) Pub. Date: Dec. 22, 2022

(54) CLOUD AUTOMATION FULFILLMENT ENABLER

(71) Applicant: Avaya Management L.P., Durham, NC (US)

(72) Inventors: Tedi Itamar Zanfolim, Sao Paulo (BR); Martin Cespedes, Buenos Aires (AR)

(21) Appl. No.: 17/461,318

(22) Filed: Aug. 30, 2021

Related U.S. Application Data
(60) Provisional application No. 63/211,409, filed on Jun. 16, 2021.

(51) Int. Cl. H04L 29/08

(52) U.S. Cl. CPC H04L 67/2809; H04L 67/32; H04L 67/141; G10L 15/22

(57) ABSTRACT

Contact centers often have data maintained, such as on site, that cannot be exposed externally, such as the data comprising sensitive information that may be at risk if it were to be exposed to a public connection. Resources available via a public network (e.g., Internet) may include natural language processing, such as to acquire and/or provide information as well as make workflow decisions with a user. By initiating a communication from the contact center to the external resource (e.g., cloud provider), a trusted communication may be established to allow the external resource to utilize natural language to process the content of the communication with the data accessed via the trusted communication.

### CROSS-REFERENCE TO RELATED APPLICATIONS

The present application claims the benefit of Provisional Patent Application No. 63/211,409, filed on Jun. 16, 2021, and is incorporated herein by reference in its entirety.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for secure communications and particularly to secure communications via an untrusted network.

### BACKGROUND

In the world of contact center automation, mainly interactive voice response (IVR) and intelligent virtual assistant (IVA), there are many contact centers that currently utilize on-premises IVR and IVA applications. These on-premises systems access the contact center's backend systems and provide automated conversation experiences with users of the contact center. The on-premises systems are trusted and have ready access to customer relationship management (CRM) applications and data and/or other systems, which may contain sensitive information. Such systems enable the contact center to consume the data on-premises and thereby avoid the need to expose sensitive systems directly to the internet, which may provide opportunities for the data to be obtained by unauthorized or other nefarious parties.

Many contact centers utilize the conversational experiences for their users by leveraging native cloud solutions, such as Google Dialogflow/Contact Center Artificial Intelligence (CCAI) and IBM Watson—examples of “cloud providers.” These conversational experiences allow for more robust and human-like conversational experiences. However, conversational experiences provided as a “cloud” service presents a fundamental issue, namely, securely providing access to sensitive data that is already available to the on-premises IVR and IVA application.

Unfortunately, the relatively simple enhancement to a contact center to enable powerful automation, such as by leveraging cloud technologies, becomes a complex endeavor that will have to address the requirements and limitations of the security measures put into place to protect sensitive data from potential exposure.

“WebSocket,” as used herein, refers to a full-duplex secure communication channel over a single transmission control protocol (TCP) connection and standardized by the Internet Engineering Task Force (IETF) as Request for Comments (RFC) 6455.

WebSocket is distinct from HTTP. Both protocols are located at layer 7 in the Open Systems Interconnect (OSI) model and depend on TCP at layer 4. Although they are different, RFC 6455 states that WebSocket “is designed to work over HTTP ports 443 and 80 as well as to support HTTP proxies and intermediaries,” thus making it compatible with HTTP. To achieve compatibility, the WebSocket handshake uses the HTTP Upgrade header to change from the HTTP protocol to the WebSocket protocol.

The WebSocket protocol enables interaction between a web browser (or other client application) and a web server with lower overhead than half-duplex alternatives such as HTTP polling, facilitating real-time data transfer from and to the server. This is made possible by providing a standardized way for the server to send content to the client without being first requested by the client, and allowing messages to be passed back and forth while keeping the connection open. In this way, a two-way ongoing conversation can take place between the client and the server. The communications are usually done over TCP port number 443 (or 80 in the case of unsecured connections), which is beneficial for environments that block non-web Internet connections using a firewall. Similar two-way browser-server communications have been achieved in non-standardized ways using stopgap technologies such as Comet.

Unlike HTTP, WebSocket provides full-duplex communication. Additionally, WebSocket enables streams of messages on top of TCP. TCP alone deals with streams of bytes with no inherent concept of a message. Before WebSocket, port 80 full-duplex communication was attainable using Comet channels; however, Comet implementation is nontrivial, and due to the TCP handshake and HTTP header overhead, it is inefficient for small messages. The WebSocket protocol aims to solve these problems without compromising the security assumptions of the web.

The WebSocket protocol specification defines ‘ws’ (WebSocket) and ‘wss’ (WebSocket Secure) as two uniform resource identifier (URI) schemes that are used for unencrypted and encrypted connections, respectively. Apart from the scheme name and fragment (i.e. “6” is not supported), the rest of the URI components are defined to use URI generic syntax. As used herein, encrypted use of WebSocket is provided, except if specifically identified as otherwise.

RFC 6455 is herein incorporated by reference for all that it teaches and is available at “datatracker.ietforg/doc/html/rfc6455”).

Cloud based conversational experiences include, but are not limited to, Google Dialogflow/CCAI, IBM Watson, or Amazon Lex.

Google Dialogflow and CCAI, which is a data extension of Google Dataflow, provide AI agents that with natural conversation ability. Virtual agents are created that seamlessly switch between topics, handle supplemental questions, and operate across multiple channels 24/7 to minimize live agent interventions.

One feature of Google Dialogflow is Agent Assist which empowers human agents with continuous support during their calls and chats by identifying intent and providing real-time, step-by-step assistance. Another feature is Insight, which uses natural language processing to identify call drivers and sentiment that helps contact center managers learn about customer interactions to improve call outcomes. Features of CCAI or Google Dataflow include speech-to-text, text-to-speech, and sentiment analysis for virtual agents. Workflows can be quickly developed and, once developed, deployed across all supported channels (e.g., voice, text, video, etc.).

Google CCAI is described at “cloud.google.com/dialogflow/priv” and all pages and subpages thereof are incorporated herein by reference for all that it discloses.

IBM Watson is a question-answering computer system capable of answering questions, and answering them in natural language.

IBM Watson is described at “ibm.com/watson” and subpages thereof are incorporated herein by reference for all that it teaches.

A “cloud,” as used herein, refers to the on-demand availability of computer system resources made available by a “cloud provider” (i.e., a business providing a cloud). The cloud comprises data storage (cloud storage) and computing hardware, without the need for direct active management by the cloud user, such as business enterprise (e.g., contact center). The term “cloud” is generally used to describe data centers available to many cloud users over the Internet. Large clouds, predominant today, often have functions distributed over multiple locations from central servers.

Clouds may be limited to a single organization (i.e., enterprise clouds), or be available to multiple organizations (i.e., public clouds).

Cloud computing relies on the sharing of resources between tasks and users to achieve coherence and economies of scale. Cloud computing operators typically take most, if not all, responsibility for managing the hardware and software components of the cloud. Load balancing allows for better management of loads including rapidly physically and/or virtually deploying additional resources to meet unexpected demands. Clouds often provide “infrastructure as a service” (IaaS) to allocate hosts, storage, and attach storage to virtual machines and may distribute processing and connection to a number of locations and support a number of communication types.

### SUMMARY

Certain prior solutions utilize a virtual private network (VPN) over the public internet to connect the on-premises backend services to the cloud-based automation engine. However, such systems require intense and careful coordination between the cloud provider and contact center part of the initial setup. Once access is provided, access to all data, including data not needed to fulfill the cloud provider's tasks, may become exposed unnecessarily absent substantial reconfiguration efforts that may disrupt other systems.

Other access, such as by exposing the existing system through an API Gateway or through development, is one of the common means available for providing data to cloud solution providers. However, such one-off connections are non-standard and, thus, may harbor unknown vulnerabilities and present cyber-attack vectors that could require substantial ongoing security management efforts that may not be available to many contact centers.

The data may be copied to the cloud provider, but this could result in inconsistent data since maintaining the data on two systems is cumbersome and always non-identical at some point in time for real-time systems. Additionally, even with today's incredibly fast data speeds, the overhead in accessing, reading, transmitting, and writing the data may be substantial, especially when compared to simple transactions.

These and other needs are addressed by the various embodiments and configurations of the present invention. The present invention can provide a number of advantages depending on the particular configuration. These and other advantages will be apparent from the disclosure of the invention(s) contained herein. The systems and methods described herein allow the existing on-premises infrastructure and services, such as those already utilized to support existing IVR and/or IVA interactions to automated agents of the contact center, to be utilized by the feature and function rich services provided by conversational agents.

The solutions herein leverage, at least in part, the fact that, although endpoints for backend components may be exposed externally to a contact center, to do so safely (e.g., thwart attempts to acquire or encrypt the data and/or install unauthorized software utilizing at least the minimum level of cyber-security presently known and considered acceptable to protect sensitive data) is a substantial burden on time, networking, processing, and other resources. Additionally, one misstep (e.g., an improper configuration or untimely update) may render such security measures, in whole or in part, ineffective. However, internal systems are more readily allowed to call external systems, such as by default settings of a firewall. However, to permit an inbound request, and yet still deny all other inbound requests, is a more complex and an error prone endeavor.

The embodiments herein improve the operation of the system by, at least in part, enabling the conversational abilities. Such systems may learn to problem solve and/or provide natural, conversational communications that would otherwise need to be more rigid (e.g., “Press 1 for new sales. Press 2 for technical support.” etc.). Conversational agents comprise automated systems utilizing speech generation and recognition to understand and communicate in natural language. For example, a user may describe a situation in detail, utilizing the terms and expressions they are familiar with, and the conversational agents may then determine what action is needed and provide (e.g., select or generate) a particular “customer journey” that resolves the issue—all without requiring routing to a human agent. In addition, benefits provided by the embodiments provided herein include, but art not limited to, allowing a contact center to incorporate cloud-deployed conversational agents to a contact center, without requiring duplication of data or exposing sensitive data to potential misuse. As a result, systems may operate more effectively with human users, which often communicate in unexpected ways, while maintaining the backend systems and data to be located on-premises.

In one embodiment, systems and methods are provided to facilitate a Fulfillment Enabler, located on a contact center's premises, to make an outbound HTTPS request to Fulfillment Enabler Proxy, deployed remotely on a cloud service, to open a secure WebSocket connection. The WebSocket connection is then a data “tunnel” used to convey requests for subsequent transactions. A solution specific automation flow (e.g., Google Dialogflow) then executes a fulfillment service and calls the Fulfillment Enabler proxy which, in turn, tunnels the request to the on-premises Fulfillment Enabler. From there, the Fulfilment Enabler, which will then execute the proper request to the customer backend service, returns the response to the tunnel.

From the foregoing, and leveraging the WebSocket protocol, requests from remote cloud systems and data located on the on-premises systems can be conveyed via the WebSocket tunnel to convey communications from the fulfillment service of the cloud service to the backend system. Such solutions maintain the security of the data and systems of the on-premises components.

Exemplary aspects are directed to:

A system for adaptive response to a communication, comprising: a processor, comprising at least one microprocessor; a network interface to a network; and wherein the processor: receives a first communication from a user device utilized by a user via the network, wherein the first communication comprises content further comprising a work item to resolve; routing the first communication to include an internal resource to attempt to resolve the work item; monitors the content of the first communication between the user device and internal resource to determine whether a natural language interaction with the user is required to resolve the work item; upon determining the content does require the natural language interaction, routes the first communication to include a second communication comprising an external resource providing natural language interactions as a portion of the content, wherein the second communication is conducted via a trusted communication channel; receives, via the trusted communication channel, a request for data from the external resource and responds thereto with the data, wherein in the data is required to resolve the work item; and in response to receiving a signal from the external resource that the work item has been resolve, terminates the first communication.
A method for adaptive response to a communication, comprising: receiving a first communication from a user device utilized by a user via a network, wherein the first communication comprises content further comprising a work item to resolve; routing the first communication to include an internal resource to attempt to resolve the work item; monitoring the content of the first communication between the user device and internal resource to determine whether a natural language interaction with the user is required to resolve the work item; upon determining the content does require the natural language interaction, routing the first communication to include a second communication comprising an external resource providing natural language interactions as a portion of the content, wherein the second communication is conducted via a trusted communication channel; receiving, via the trusted communication channel, a request for data from the external resource and responding thereto with the data, wherein in the data is required to resolve the work item; and in response to receiving a signal from the external resource that the work item has been resolve, terminating the first communication.
A system for adaptive response to a communication, comprising: means to receive a first communication from a user device utilized by a user via a network, wherein the first communication comprises content further comprising a work item to resolve; means to route the first communication to include an internal resource to attempt to resolve the work item; means to monitor the content of the first communication between the user device and internal resource to determine whether a natural language interaction with the user is required to resolve the work item; means to, upon determining the content does require the natural language interaction, route the first communication to include a second communication comprising an external resource providing natural language interactions as a portion of the content, wherein the second communication is conducted via a trusted communication channel; means to receive, via the trusted communication channel, a request for data from the external resource and responding thereto with the data, wherein in the data is required to resolve the work item; and means to, in response to receiving a signal from the external resource that the work item has been resolve, terminate the first communication.
Any of the above aspects:
wherein the external resource comprises a cloud provider, wherein the cloud provider comprises a plurality of computational, data storage, and communication resources dynamically allocated for use by the system to appear to the system as dedicated resources;
wherein the processor initiates the trusted communication with the external resource comprising, sending a hypertext transfer protocol secure (HTTPS) request to the cloud provider.
wherein the external resource, in response to the HTTPS request, establishes the trusted communication comprising a WebSocket tunnel;
wherein the external resource, in response to the HTTPS request, establishes the trusted communication comprising a Web Real-Time Communication (WebRTC) channel;
wherein at least one of the first communication or the second communication comprises packetized communication compliant with Session Initiation Protocol (SIP) messages and media streaming;
wherein upon determining the content does not require the natural language interaction, resolving the work item by the internal resource and omitting communications with the second resource;
wherein the first resource comprises a fulfillment enabler, wherein the fulfillment enabler establishes the second communication with the trusted resource;
wherein the request for the data is received by the internal resource further comprising a fulfillment enabler and wherein the fulfillment enabler receives the request for the data from the external resource, requests the data from a data component, and provides the results received from the data component to the external resources;
wherein the fulfillment enabler receives the request from the external resource comprising a fulfillment enabler proxy, and provides the data to the fulfillment enabler proxy;
wherein the natural language interaction comprises at least one workflow decision determined from a value of the data;
wherein the natural language interaction with the user is required to resolve the work item, upon the processor determining that the work item is absent a request known to the internal resource and having a known resolution known to the resource;
wherein the external resource comprises a cloud provider, wherein the cloud provider comprises a plurality of computational, data storage, and communication resources dynamically allocated for use by the system to appear to the system as dedicated resources;
wherein the trusted communication with the external resource comprising, sending a hypertext transfer protocol secure (HTTPS) request to the cloud provider;
further comprising, in response to the HTTPS request, establishing the trusted communication comprising establishing a WebSocket tunnel;
wherein the external resource, in response to the HTTPS request, establishing the trusted communication comprising establishing a Web Real-Time Communication (WebRTC) channel.
wherein at least one of the first communication or the second communication comprises packetized communication compliant with Session Initiation Protocol (SIP) messages and media streaming; and
wherein upon determining the content does not require the natural language interaction, resolving the work item by the internal resource and omitting communications with the second resource.

A system on a chip (SoC) including any one or more of the above aspects.

One or more means for performing any one or more of the above aspects.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects, wherein the data storage comprises a non-transitory storage device comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a second system in accordance with embodiments of the present disclosure;

FIG. 3 depicts an interaction in accordance with embodiments of the present disclosure;

FIG. 4 depicts a first process in accordance with embodiments of the present disclosure;

FIG. 5 depicts a second process in accordance with embodiments of the present disclosure;

FIG. 6 depicts a second system in accordance with embodiments of the present disclosure;

and

FIG. 7 depicts a third system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with a like reference number. When such a reference is made in the singular form, but without identification of the sub-reference identifier, is a reference to one of the like numbered elements, but without limitation as to the particular one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

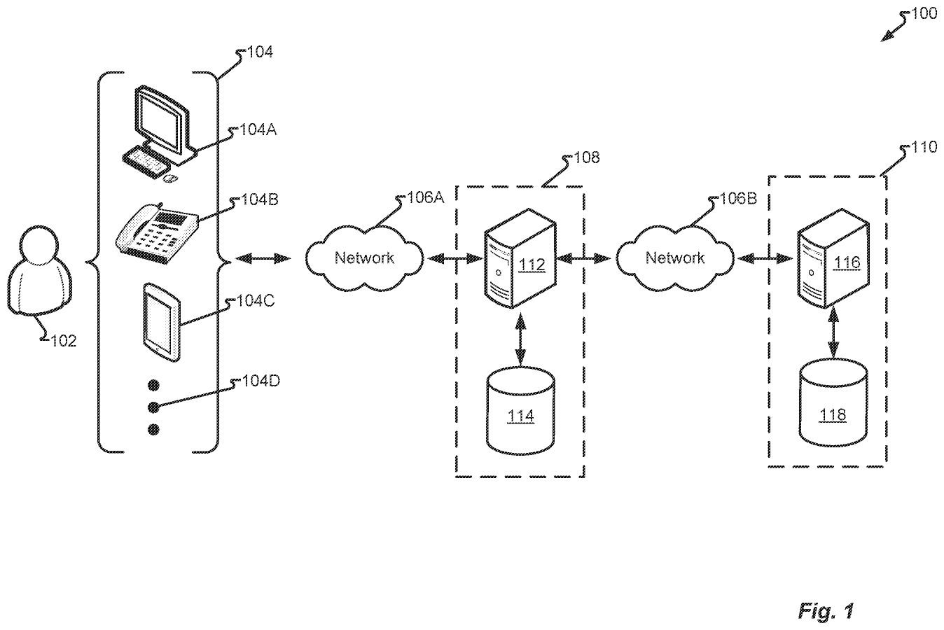

FIG. 1 depicts system 100 in accordance with embodiments of the present disclosure. In one embodiment, user 102 utilizes user device 104 to communicate with contact center 108 via network 106A. The communication may be initiated by user 102 or contact center 108. User device 104 is variously embodied and may include any device operable to communicate via network 106A with contact center 108, such as computer 104A, telephone 104B, smart phone 104C, and/or other device(s) 104D (illustrated as ellipses). The particular user device 104 utilized may determine, in whole or in part, communication types that are, or are not, available. For example, computer 104A may be enabled to communicate textually, audio (with integrated and/or peripheral microphone and speaker (not shown)), video (with monitor and integrated and/or peripheral camera (not shown)), document sharing, document sharing, co-browsing and/or other communication, such as a custom application (e.g., Back-to-Back (B2B) user agent). Telephone 104B may be a digital telephone, such as an endpoint (e.g., B2B user agent) configured to utilize Session Initiation Protocol (SIP) messaging and associated media stream (e.g., WebRTC), to communicate with packetized audio and optionally other content (e.g., presence) communicating on a packet switched network (e.g., Intranet/Internet). Additionally or alternatively, telephone 104B may be an analog telephone, such as to communicate utilized Plain Old Telephone System (POTS) on a circuit-switched network, such as a public switched telephone network (PSTN). Smart phone 104C may be embodied as a wireless network (e.g., BlueTooth, WiFi, and/or cellular network) attached device, to communicate via analog and/or digital signals. It should be appreciated that features of one device may be implemented on other devices, for example smart phone 104C may communicate utilizing wired communication or by deploying a communication application (e.g., B2B user agent).

Network 106 is illustrated herein as a first and second portion, network 106A and network 106B, respectively. First and second portions 106A and 106B may be or comprise the same network or portions of the same network, such as the Internet or be distinct. For example first portion 106A may comprise a PSTN telephone network whereas second portion of network 106B may be a public network (e.g., Internet). As used herein, at least second portion 106B is an untrusted public network (e.g., Internet) unless expressly stated otherwise, whereas first portion 106A may similarly be the same or other untrusted public network, or portion thereof, and/or other network (e.g., PSTN, cellular, etc.). Second portion 106B is untrusted meaning that communications thereon maybe “spoofed” (e.g., a node on second portion 106B is intentionally misidentified) and/or communications may be monitored by third-parties, such as nefarious hardware and software. Other forms of attack and/or exposure of data to unauthorized parties may be possible on second portion 106B and, therefore, precautions needed to help protect the data transmitted thereon from being received (at all or at least in non-encrypted form) by any unauthorized party. First portion 106A may similarly be subject to data-theft by a nefarious hardware and/or software, and as a result known security precautions may be deployed to protect the data transmitted thereon. The security measures contemplated herein are believed to ensure data protection, when properly implemented, while providing the distributed processing of data during an interaction with user 102 between contact center 108, and the resources therein, and external resource 110, and the resources therein.

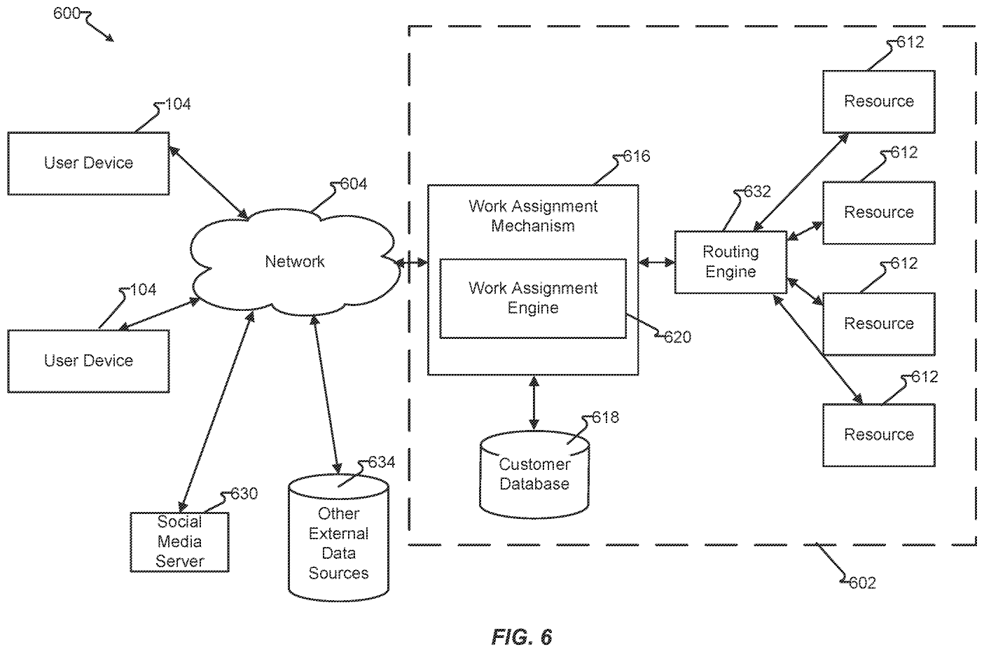

In one embodiment, contact center 108 comprises internal server 112 and internal data storage 114 to process and maintain data, such as data associated with a customer (e.g., user 102). During a communication with user 102, contact center 108 may create or identify a work time to be resolved. The work item, which is described more completely with respect to system 600 (see, FIG. 6), may be a request for information (e.g., “What is my account balance?” “What time does my flight land?” etc.). As contemplated with respect to the embodiments herein, the request for resolution of a work item will include and/or require at least one sensitive datum or data in order to respond (e.g., an account number, a frequent flier number, a credit card number, social security number, etc.). Work items that do not request, nor require for processing, any sensitive information (e.g., “What is the weather in Tokyo next week?”) may be processed utilizing the systems and methods described herein and/or be processed via conventional means.

Internal server 112 and internal data storage 114 may comprise a single server and database structure, as illustrated, or a more complex system, such as when internal server 112 comprises a number of servers, routers, edge devices, networking components, etc., and internal data storage 114 comprises a number of storage devices (e.g., array, farm, etc.), as may be utilized to support a number, often a large number (e.g., thousands), of simultaneous communications with a corresponding number of individual users 102. Contact center 108, via internal server 112 and/or internal data storage 114 may comprise a number of backend systems, such as customer resource management (CRM), databases, process, workflows, etc.) and data records. Contact center 108 may be a dedicated contact center for a single enterprise (e.g., providing services by or on behalf of a single airline, bank, or insurance company) or a number of enterprises.

In another embodiment, contact center 108 is connected to user 102 for a communication. The communication comprises content (e.g., speech, text messages, dual tone multi-frequency (DTMF) signals, etc.). Initially, the communication may be routed to one resource of network 106, such as internal server 112 which may implement an automated agent, such as an interactive voice response (IVR) system, intelligent virtual assistant (IVA), or similar agent (e.g., DTMF-based decision tree). An automated agent, such as one executing on internal server 112 may monitor the communication to determine whether natural language processing is required in order to resolve the work item. In one embodiment, natural language processing is required when the work item has an unknown or initially unknowable request. For example, the communication may comprise speech from user 102 saying “agent,” “customer service,” or “other” in response to a prompt to identify the reason for the communication, and thereby identify the type of work item. In another example, the communication may be determined to require natural language processing when the request is not a known or knowable request. For example, a known or knowable request may be the result of user 102 selecting (via speech and/or DTMF signals) a finite option, such as “Press or say ‘3’ for account balance,” and user 102 did select option ‘3’. As a result, internal systems alone (e.g., accessing a backend system, such as to access one or more records from internal data storage 114) may be accessed to resolve the work item (e.g., provide the account balance).

In another embodiment, when the work item is unknown (e.g., selecting “other” or asking for “supervisor” or “agent”) or initially unknowable (e.g., providing an incoherent response to a prompt to “briefly state your question or issue.”). Additionally or alternatively, contact center 108 may determine natural language processing is required based on other information. For example, if contact center 108 is supporting an insurance enterprise and user 102, in the process of applying for an insurance policy, was previously told to provide an explanation or other details in response to a question but disconnected the prior communication before providing the details. Accordingly, contact center 108 may receive a subsequent communication and associate the caller (e.g., via Caller-ID or provided name or other identifier) or known work item (e.g., “press 5 to continue an existing application”) with a prior work item, which may be known to require the use of natural language processing in order to resolve the work item, such as to complete the application.

In another embodiment, external resource 110 provides at least one service not presently available, or available to the same extent, by contact center 108. For example, external resource 110 may provide natural language processes to, in natural speech, interact with user 102. Additionally or alternatively, external resource 110 may execute a workflow based, in whole or in part, on the interaction. For example, user 102 may be engaged in a communication with contact center 108 and be routed to include external resource 110, such as external computational device 116 accessing external data storage 118 via network 106B. External resource 110 may deploy artificial intelligent agents, such as trained neural network, and/or other automated agents executing on external computational device 116 to engage in conversational speech (e.g., “Tell me how I can help.”) and receive and process speech from user 102 (e.g., “When my flight was overbooked, the gate staff said we were entitled to a $300 voucher. It's been a month and I haven't received it.”). External computational device 116 may then parse the speech provided to determine what action are required, which may include loading or selecting a particular workflow (e.g., process promised voucher). This may include accessing rules of speech, grammar, language, as well as workflow-specific rules (e.g., Determine if the customer was on a flight that was authorized for a voucher.).

External resource 110 may have certain rules and data, such as maintained in external data storage 118, to process speech and generate speech, it should be appreciated that other forms of communication may be utilized without departing from the scope of the embodiments herein, such as text and audio-video.

External resource 110 may not have all information required in order to resolve the work item. For example, external computational device 116 may have some portion of a workflow (e.g., ask the customer their name, account number, reason for the call, etc.) and provide one or more responses (e.g., “Sure, I can help you with that. Let me look up your account information.”). Additionally or alternatively, external computational device 116 may, via the automated interaction, provide a more natural response such as banter (e.g., “How is your day going?” “Did you get any of that rain that came through your area last night?”, etc.) and processes such responses, even if ancillary to the work item. However, certain information may be essential to processing the work item (e.g., determine if this customer is entitled to a voucher, whether a voucher was sent, if a voucher was sent, was it sent to the correct address or email, etc.). Such information may require knowledge of information maintained in internal data storage 114.

In order to select and/or process the appropriate workflow to resolve the work item, external resource 110 utilizes a secure connection between network 106 and external resource 110 and comprising network 106B in order to obtain data from contact center 108 (e.g., internal data storage 114 and/or internal server 112). Accordingly, a secure means of communication is required between contact center 108 and external resource 110 to provide the data, which may comprise sensitive information (e.g., account number, credit card number, social security number, address, medical information, etc.) or otherwise require protection to avoid exposing the data to any unauthorized party. For example, obtaining a financial transaction record from internal data storage 114 may determine if user 102 was provided with some other form of compensation that was owed, such as, “You did not receive a voucher because your entire ticket price was refunded. If you look at your credit card statement on the 19^{th} of last month . . . ”

Contact center 108, receiving a request for data via network 106B must be considered suspect. A nefarious actor could be imitating external resource 110 or otherwise attempting to obtain the data. As a result, receiving requests is a risky endeavor. That risk is significantly attenuated if contact center 108 initiates the communication with external resource 110, establishes a secure connection therebetween, and then receives the request for the data via the secure connection. Accordingly, contact center 108 initially sends a setup message, such as a secure hypertext transfer protocol (HTTPS) message to external resource 110 to establish a secure connection, such as utilizing WebSocket, and receives the request for the data via the secure channel. Any other requests for the data received via all other means, or at least all other non-secure channels, is discarded, ignored, or otherwise treated as illegitimate and not processed or responded to.

External resource 110 may be a cloud provider, such as an enterprise providing hardware executing software to one or more users (e.g., contact center 108 and optionally other entities in multi-tenant implementations). External resource 110 may utilize virtual machines to provide shared hardware as appearing to be dedicated hardware, such as to accommodate load balancing, geographical diversity, backup, redundancies, and/or other services. As a benefit, natural language skills learned in prior communications, which may be with the same or different contact center 108, may be utilized to train neural networks or other systems of external resource 110 to enable more conversational communications. For example, idioms or other forms of speech, which may be, in whole or in part, dependent on age, gender, national origin, or other aspect of a user may be learned for one entitle and made available to contact center 108 by external resource 110.

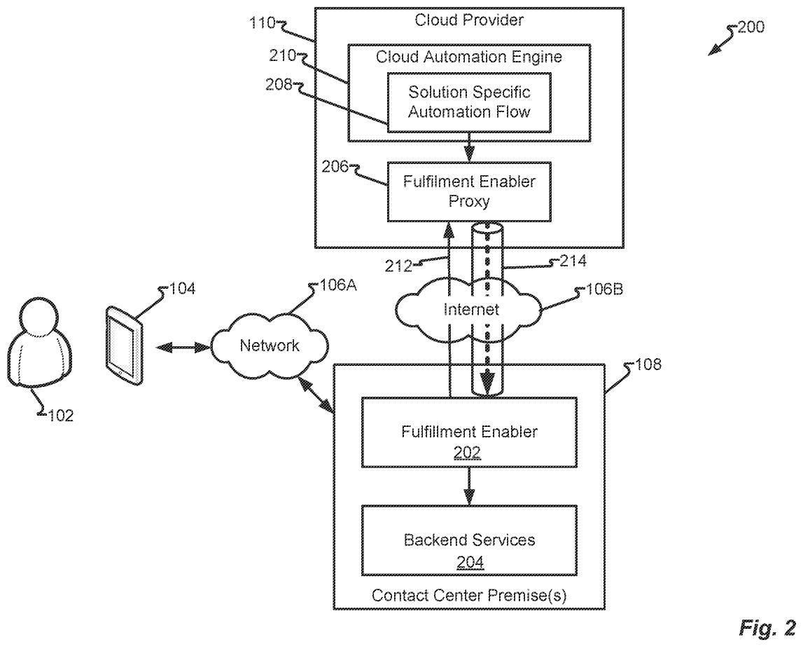

FIG. 2 depicts system 200 in accordance with embodiments of the present disclosure. In one embodiment, user device 104, with inputs from and out puts to user 102, is connected with contact center 108 via network 106A. A work item is initiated which may be generic or unknown (e.g., determine the reason for the communication) or more finite or known (e.g., provide user 102 with their account balance). Contact center 108, such as via a service running on internal server 112, may execute fulfillment enabler 202. In one embodiment, fulfillment enabler 202 may route the communication to another agent executing on internal server 112, such as when the other agent is able to resolve the work item without requiring natural language interaction (e.g., provide user 102 with their account balance). In another embodiment, fulfillment enabler 202 may require use of natural language processing provided by external resource 110.

External resource 110 establishes a secure communication channel with external resource 110, such as via making an outbound HTTPS requests to an agent executing on external computational device 116 of external resource 110, such as a provided fulfillment enabler proxy 206. In response to the HTTPS request, fulfillment enabler proxy 206 responds and external resource 110 and contact center 108, via fulfillment enabler proxy 206 and fulfillment enabler 202, establish secure connection 214 via network 106B. In one embodiment, secure connection 214 is a WebSocket connection, which may utilize SIP messages and media and/or other communication, such as WebRTC, therebetween. As a result, the request for the data, and optionally subsequent requests for the same or different data, are then tunneled via secure connection 214.

In another embodiment, solution specific automation flow 208, (e.g., Google Dialogflow automation), is utilized to execute a fulfillment service for data. Solution specific automation flow 208, which may be executed as a service of an automation engine (e.g., cloud automation engine 210) calls fulfillment enabler proxy 206 which, in turn, tunnels the request via secure connection 214 to fulfillment enabler 202. Fulfillment enabler 202 then calls backend services 204 to obtain the data, such as an application (e.g., CRM, payroll, medical record, etc.) and/or other data access or data access via an application, whether raw or processed (e.g., calculated, combined, etc.).

As a benefit, from the perspective of contact center 108, the data is maintained by contact center 108, which may be physically on equipment within the physical confines of contact center 108 that calls an external service fulfillment enabler proxy 206 to obtain services, such as natural language processing. Changes required to contact center 108 to implement secure connectivity with external resource 110 are minimal.

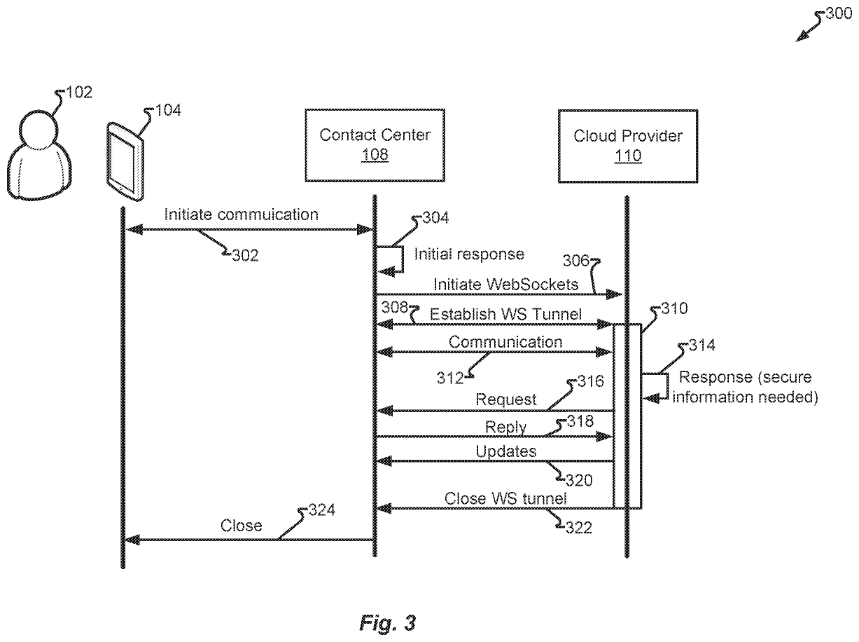

FIG. 3 depicts interaction 300 in accordance with embodiments of the present disclosure. In one embodiment, interaction 300 is automatically executed and beings with event 302 which initiates a communication to connect user 102, via user device 104 connects to a resource of contact center 108, such as a resource executing on internal server 112. Event 304 processes an initial response to determine if a natural language process of external resource 110 is required. If not, contact center 108 response. If so, event 306 initiates a secure connection, such an HTTPS request to initiate a WebSocket channel. Event 308 establishes the WebSocket channel initiating process 310 to provide natural language processing. Event 312 is then conducted between contact center 108 and external resource 110. Event 314 may occur wherein data is determined to be needed form contact center 108 in order to select and/or carry out a particular workflow to resolve a work item. Event 316 then, via a tunneled connection with contact center 108 requests the data and, in event 318 receives the data.

Event 320 may performed to close a particular transaction, such as to cause contact center 108 to commit any updates to internal data storage 114, such as to create, delete, or updating a record held therein with updated information that resulted form execution of the workflow associated with the communication and/or user 102. Optionally, event 322 may close the secure connection or, alternatively, leave the connection open for a subsequent request with the same or different communication. Event 324 ends the communication between user device 104 and contact center 108.

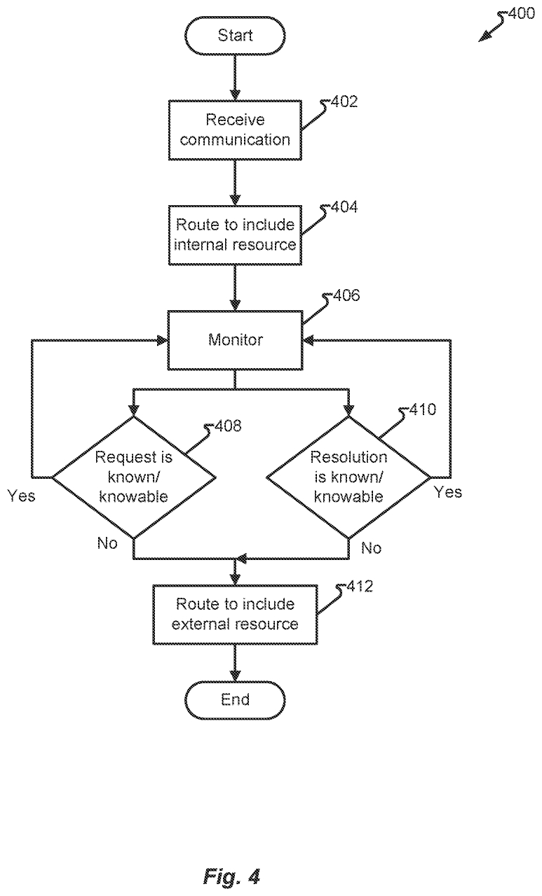

FIG. 4 depicts process 400 in accordance with embodiments of the present disclosure. In one embodiment, process 400 is automatically executed by a processor, comprising one or more microprocessors, such as a processor of internal server 112 of contact center 108. Process 400 begins and, in step 402 receives a communication. The communication may be inbound, and initiated by user device 104, or outbound, initiated by a component of contact center 108. Step 404 routes the communication to an internal resources, such as an IVR, IVA system or other automated agent to perform at least a portion of a workflow, such as to determine the particular issue and/or workflow to be resolved as a result of the communication. Step 406 monitors the communication to determine, in test 408, if the request is known or knowable, and/or if the resolution is known or knowable, in test 410. If at least one of tests 408 or 410 is determined in the affirmative, processing returns to step 406, which may loop until the process 400 is interrupted, and the communication ends, or both of test 408 and test 410 are determined in the negative.

In one embodiment, test 408 determines if the request is knowable if the work item comprises an action (e.g., perform a transaction, provide information, etc.) that is understood and/or known to contact center 108 or a resource therein. For example, if the communication specifically asks user 102 to select an option, the options having one or more responses or type of response that are known to contact center 108, then test 408 is determined in the affirmative, such as to allow contact center 108 to process the work item, for example, receiving a DTMF tone for ‘3’ in response to the prompt “Press ‘3’ for account balance,” wherein the account balance for all users (user 102 being one) are known within contact center 108. Test 410 may be determined in the affirmative if the resolution is known or knowable. For example, user 102 may speak, “change my flight,” which may be a known operation on a set of data maintained by contact center 108 even if the specific flight and/or user has not yet been determined. In contrast, one or both of 408 and/or 410 may be determined in the affirmative if the question is unclear (e.g., gibberish, ranting, etc.) or specifically identified as “other,” such as requesting “agent” or “supervisor” or, when provided with a list of options, selects “other.” It should be appreciated that test 408 and 410 may be performed in parallel or series and/or combined.

If test 408 and/or test 410 is determined in the negative, processing continues to step 412 to include an external resource in the communication. The external resource may provide natural language services, via automated systems, and/or other services.

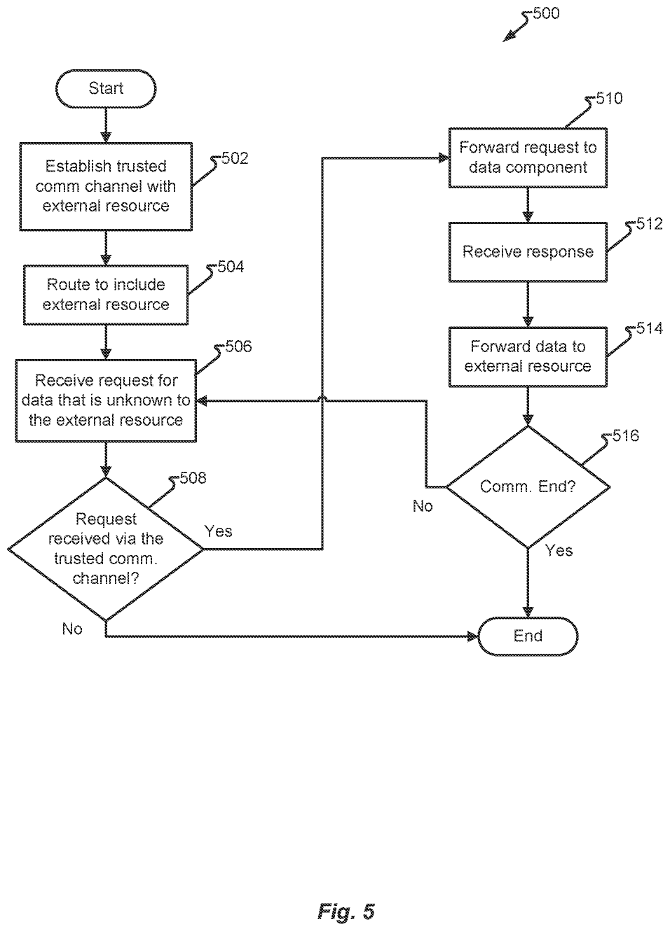

FIG. 5 depicts process 500 in accordance with embodiments of the present disclosure. In one embodiment, process 500 is automatically executed by a processor, comprising one or more microprocessors, such as a processor of internal server 112 of contact center 108. Process 500 begins and, in step 502 a trusted communication channel is established between contact center 108 and external resource 110 via an untrusted network (e.g., network 106B) utilizing a secure channel (e.g., WebSocket). Step 504 routes a communication to include the external resource, or a portion thereof, as a node in a communication network comprising an endpoint (e.g., user device 104) and optionally, contact center 108. Step 506 receives a request for data that is unknown to the external source. test 508 then determines if the request for the data is via the trusted communication channel. If test 508 is determined in the negative, process 500 ends. If test 508 is determined in the affirmative, processing continues to step 510.

Step 510 forwards the request for the data to a data component. The data component may be a database, record, structure, memory value, etc. and/or an output from an application or other process in step 512. For example, a banking application may be asked for the data “net balance of all accounts,” which requires an application to acquire balances from individual accounts and aggregate the results into the file data. Step 514 forwards the data to the extern resource and, in test 516 determines if the communication has ended. If not, process 500 may continue back to step 506 to receive another request for data from the external resource. If test 516 is determined in the affirmative, process 500 ends.

FIG. 6 depicts system 600 in accordance with embodiments of the present disclosure. The communication system 600 may be a distributed system and, in some embodiments, comprises a communication network 106 connecting one or more customer communication devices 608 to a work assignment mechanism 616, which may be owned and operated by an enterprise administering contact center 602 in which a plurality of resources 612 is distributed to handle incoming work items (in the form of contacts) from customer communication devices 608. In one embodiment, contact center 108 is embodied as contact center 602.

Contact center 602 is variously embodied to receive and/or send messages that are or are associated with work items and the processing and management (e.g., scheduling, assigning, routing, generating, accounting, receiving, monitoring, reviewing, etc.) of the work items by one or more resources 612. The work items are generally generated and/or received requests for a processing resource 612 embodied as, or a component of, an electronic and/or electromagnetically conveyed message. Contact center 602 may include more or fewer components than illustrated and/or provide more or fewer services than illustrated. The border indicating contact center 602 may be a physical boundary (e.g., a building, campus, etc.), legal boundary (e.g., company, enterprise, etc.), and/or logical boundary (e.g., resources 612 utilized to provide services to customers for a customer of contact center 602).

Furthermore, the border illustrating contact center 602 may be as-illustrated or, in other embodiments, include alterations and/or more and/or fewer components than illustrated. For example, in other embodiments, one or more of resources 612, customer database 618, and/or other component may connect to routing engine 632 via communication network 106, such as when such components connect via a public network (e.g., Internet). In another embodiment, communication network 106 may be a private utilization of, at least in part, a public network (e.g., VPN); a private network located, at least partially, within contact center 602; or a mixture of private and public networks that may be utilized to provide electronic communication of components described herein. Additionally, it should be appreciated that components illustrated as external, such as social media server 630 and/or other external data sources 634 may be within contact center 602 physically and/or logically, but still be considered external for other purposes. In one embodiment, external resource 110 is embodied as external data source 634. For example, contact center 602 may operate social media server 630 (e.g., a website operable to receive user messages from customers and/or resources 612) as one means to interact with customers via their user device 104.

Customer communication devices 608 are embodied as external to contact center 602 as they are under the more direct control of their respective user or customer. However, embodiments may be provided whereby one or more customer communication devices 608 are physically and/or logically located within contact center 602 and are still considered external to contact center 602, such as when a customer utilizes user device 104 at a kiosk and attaches to a private network of contact center 602 (e.g., WiFi connection to a kiosk, etc.), within or controlled by contact center 602.

It should be appreciated that the description of contact center 602 provides at least one embodiment whereby the following embodiments may be more readily understood without limiting such embodiments. Contact center 602 may be further altered, added to, and/or subtracted from without departing from the scope of any embodiment described herein and without limiting the scope of the embodiments or claims, except as expressly provided.

Additionally, contact center 602 may incorporate and/or utilize social media server 630 and/or other external data sources 634 may be utilized to provide one means for a resource 612 to receive and/or retrieve contacts and connect to a customer of a contact center 602. Other external data sources 634 may include data sources, such as service bureaus, third-party data providers (e.g., credit agencies, public and/or private records, etc.), such as external resource 110. Customers may utilize their respective user device 104 to send/receive communications utilizing social media server 630.

In accordance with at least some embodiments of the present disclosure, the communication network 106 may comprise any type of known communication medium or collection of communication media and may use any type of protocols to transport electronic messages between endpoints. The communication network 106 may include wired and/or wireless communication technologies. The Internet is an example of the communication network 106 that constitutes an Internet Protocol (IP) network consisting of many computers, computing networks, and other communication devices located all over the world, which are connected through many telephone systems and other means. Other examples of the communication network 106 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 106 need not be limited to any one network type and instead may be comprised of a number of different networks and/or network types. As one example, embodiments of the present disclosure may be utilized to increase the efficiency of a grid-based contact center 602. Examples of a grid-based contact center 602 are more fully described in U.S. Patent Publication No. 2010/0296417 to Steiner, the entire contents of which are hereby incorporated herein by reference. Moreover, the communication network 106 may comprise a number of different communication media, such as coaxial cable, copper cable/wire, fiber-optic cable, antennas for transmitting/receiving wireless messages, and combinations thereof.

The customer communication devices 608 may correspond to customer communication devices. In accordance with at least some embodiments of the present disclosure, a customer may utilize their user device 104 to initiate a work item. Illustrative work items include, but are not limited to, a contact directed toward and received at a contact center 602, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 106. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 616, but rather may be on some other server in the communication network 106 where it is harvested by the work assignment mechanism 616, which generates a work item for the harvested communication, such as social media server 630. An example of such a harvested communication includes a social media communication that is harvested by the work assignment mechanism 616 from a social media server 630 or network of servers. Exemplary architectures for harvesting social media communications and generating work items based thereon are described in U.S. patent application Ser. Nos. 12/784,369, 12/706,942, and 12/707,277, filed Mar. 20, 2010, Feb. 17, 2010, and Feb. 17, 2010, respectively; each of which is hereby incorporated herein by reference in its entirety.

The format of the work item may depend upon the capabilities of the user device 104 and the format of the communication. In particular, work items are logical representations within a contact center 602 of work to be performed in connection with servicing a communication received at contact center 602 (and, more specifically, the work assignment mechanism 616). The communication may be received and maintained at the work assignment mechanism 616, a switch or server connected to the work assignment mechanism 616, or the like, until a resource 612 is assigned to the work item representing that communication. At which point, the work assignment mechanism 616 passes the work item to a routing engine 632 to connect the user device 104, which initiated the communication, with the assigned resource 612.

Although the routing engine 632 is depicted as being separate from the work assignment mechanism 616, the routing engine 632 may be incorporated into the work assignment mechanism 616 or its functionality may be executed by the work assignment engine 620.

In accordance with at least some embodiments of the present disclosure, the customer communication devices 608 may comprise any type of known communication equipment or collection of communication equipment. Examples of a suitable user device 104 include, but are not limited to, a personal computer, laptop, Personal Digital Assistant (PDA), cellular phone, smart phone, telephone, or combinations thereof. In general, each user device 104 may be adapted to support video, audio, text, and/or data communications with other customer communication devices 608 as well as the processing resources 612. The type of medium used by the user device 104 to communicate with other customer communication devices 608 or processing resources 612 may depend upon the communication applications available on the user device 104.

In accordance with at least some embodiments of the present disclosure, the work item is sent toward a collection of processing resources 612 via the combined efforts of the work assignment mechanism 616 and routing engine 632. The resources 612 can either be completely automated resources (e.g., IVR, IVA, microprocessors, servers, or the like), or any other resource known to be used in contact center 602.

As discussed above, the work assignment mechanism 616 and resources 612 may be owned and operated by a common entity in a contact center 602 format. In some embodiments, the work assignment mechanism 616 may be administered by multiple enterprises, each of which has its own dedicated resources 612 connected to the work assignment mechanism 616.

In some embodiments, the work assignment mechanism 616 comprises a work assignment engine 620, which enables the work assignment mechanism 616 to make intelligent routing decisions for work items. In some embodiments, the work assignment engine 620 is configured to administer and make work assignment decisions in a queueless contact center 602, as is described in U.S. patent application Ser. No. 12/882,950, the entire contents of which are hereby incorporated herein by reference. In other embodiments, the work assignment engine 620 may be configured to execute work assignment decisions in a traditional queue-based (or skill-based) contact center 102.

The work assignment engine 620 and its various components may reside in the work assignment mechanism 616 or in a number of different servers or processing devices. In some embodiments, cloud-based computing architectures can be employed whereby one or more hardware components of the work assignment mechanism 616 are made available in a cloud or network such that they can be shared resources among a plurality of different users. Work assignment mechanism 616 may access customer database 618, such as to retrieve records, profiles, purchase history, previous work items, and/or other aspects of a customer known to contact center 602. Customer database 618 may be updated in response to a work item and/or input from resource 612 processing the work item. Database 618 may be one embodiment of internal data storage 114.

It should be appreciated that one or more components of contact center 602 may be implemented in a cloud-based architecture in their entirety, or components thereof (e.g., hybrid), in addition to embodiments being entirely on-premises. In one embodiment, user device 104 is connected to one of resources 612 via components entirely hosted by a cloud-based service provider, wherein processing and data storage hardware components may be dedicated to the operator of contact center 602 or shared or distributed amongst a plurality of service provider customers, one being contact center 602.

In one embodiment, a message is generated by user device 104 and received, via communication network 106, at work assignment mechanism 616. The message received by a contact center 602, such as at the work assignment mechanism 616, is generally, and herein, referred to as a “contact.” Routing engine 632 routes the contact to at least one of resources 612 for processing.

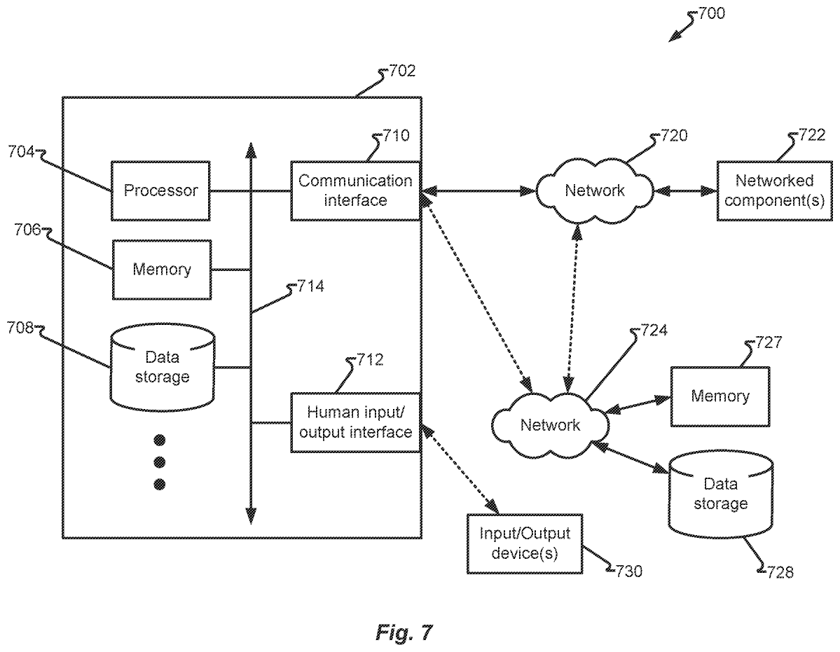

FIG. 7 depicts device 702 in system 700 in accordance with embodiments of the present disclosure. In one embodiment, one or more of user device 104, internal server 112, external computational device 116 may be embodied, in whole or in part, as device 702 comprising various components and connections to other components and/or systems. The components are variously embodied and may comprise processor 704. The term “processor,” as used herein, refers exclusively to electronic hardware components comprising electrical circuitry with connections (e.g., pin-outs) to convey encoded electrical signals to and from the electrical circuitry. Processor 704 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 714, executes instructions, and outputs data, again such as via bus 714. In other embodiments, processor 704 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 704 is a non-transitory computing device (e.g., electronic machine comprising circuitry and connections to communicate with other components and devices). Processor 704 may operate a virtual processor, such as to process machine instructions not native to the processor (e.g., translate the VAX operating system and VAX machine instruction code set into Intel® 9xx chipset code to allow VAX-specific applications to execute on a virtual VAX processor), however, as those of ordinary skill understand, such virtual processors are applications executed by hardware, more specifically, the underlying electrical circuitry and other hardware of the processor (e.g., processor 704). Processor 704 may be executed by virtual processors, such as when applications (i.e., Pod) are orchestrated by Kubernetes. Virtual processors allow an application to be presented with what appears to be a static and/or dedicated processor executing the instructions of the application, while underlying non-virtual processor(s) are executing the instructions and may be dynamic and/or split among a number of processors.

In addition to the components of processor 704, device 702 may utilize memory 706 and/or data storage 708 for the storage of accessible data, such as instructions, values, etc. Internal data storage 114 and/or external data storage 118 may be embodied as data storage 708, data storage 728, memory 706, and/or memory 727. Communication interface 710 facilitates communication with components, such as processor 704 via bus 714 with components not accessible via bus 714. Communication interface 710 may be embodied as a network port, card, cable, or other configured hardware device. Additionally or alternatively, human input/output interface 712 connects to one or more interface components to receive and/or present information (e.g., instructions, data, values, etc.) to and/or from a human and/or electronic device. Examples of input/output devices 730 that may be connected to input/output interface include, but are not limited to, keyboard, mouse, trackball, printers, displays, sensor, switch, relay, speaker, microphone, still and/or video camera, etc. In another embodiment, communication interface 710 may comprise, or be comprised by, human input/output interface 712. Communication interface 710 may be configured to communicate directly with a networked component or utilize one or more networks, such as network 720 and/or network 724, which may be embodied as network 106 or a portion therefore (network 106A or network 106B).

Network 106, or one of network 106A or network 106B, may be embodied, in whole or in part, as network 720. Network 720 may be a wired network (e.g., Ethernet), wireless (e.g., WiFi, Bluetooth, cellular, etc.) network, or combination thereof and enable device 702 to communicate with networked component(s) 722. In other embodiments, network 720 may be embodied, in whole or in part, as a telephony network (e.g., public switched telephone network (PSTN), private branch exchange (PBX), cellular telephony network, etc.)

Additionally or alternatively, one or more other networks may be utilized. For example, network 724 may represent a second network, which may facilitate communication with components utilized by device 702. For example, network 724 may be an internal network to a business entity or other organization, such as contact center 108, whereby components are trusted (or at least more so) that networked components 722, which may be connected to network 720 comprising a public network (e.g., Internet) that may not be as trusted.

Components attached to network 724 may include memory 726, data storage 728, input/output device(s) 730, and/or other components that may be accessible to processor 704. For example, memory 726 and/or data storage 728 may supplement or supplant memory 706 and/or data storage 708 entirely or for a particular task or purpose. For example, memory 726 and/or data storage 728 may be an external data repository (e.g., server farm, array, “cloud,” etc.) and allow device 702, and/or other devices, to access data thereon. Similarly, input/output device(s) 730 may be accessed by processor 704 via human input/output interface 712 and/or via communication interface 710 either directly, via network 724, via network 720 alone (not shown), or via networks 724 and 720. Each of memory 706, data storage 708, memory 726, data storage 728 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 730 may be a router, switch, port, or other communication component such that a particular output of processor 704 enables (or disables) input/output device 730, which may be associated with network 720 and/or network 724, to allow (or disallow) communications between two or more nodes on network 720 and/or network 724. For example, a connection between one particular customer, using a particular user device 104, may be enabled (or disabled) with a particular networked component 722 and/or particular resource 712. Similarly, one particular networked component 722 and/or resource 712 may be enabled (or disabled) from communicating with a particular other networked component 722 and/or resource 712, including, in certain embodiments, device 702 or vice versa. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system for adaptive response to a communication, comprising:
a processor, comprising at least one microprocessor;
a network interface to a network; and
wherein the processor:
receives a first communication from a user device utilized by a user via the network, wherein the first communication comprises content further comprising a work item to resolve;
routing the first communication to include an internal resource to attempt to resolve the work item;
monitors the content of the first communication between the user device and internal resource to determine whether a natural language interaction with the user is required to resolve the work item;
upon determining the content does require the natural language interaction, routes the first communication to include a second communication comprising an external resource providing natural language interactions as a portion of the content, wherein the second communication is conducted via a trusted communication channel;
receives, via the trusted communication channel, a request for data from the external resource and responds thereto with the data, wherein in the data is required to resolve the work item; and
in response to receiving a signal from the external resource that the work item has been resolve, terminates the first communication.

2. The system of claim 1, wherein the external resource comprises a cloud provider, wherein the cloud provider comprises a plurality of computational, data storage, and communication resources dynamically allocated for use by the system to appear to the system as dedicated resources.

3. The system of claim 1, wherein the processor initiates the trusted communication with the external resource comprising, sending a hypertext transfer protocol secure (HTTPS) request to the cloud provider.

4. The system of claim 3, wherein the external resource, in response to the HTTPS request, establishes the trusted communication comprising a WebSocket tunnel.

5. The system of claim 3, wherein the external resource, in response to the HTTPS request, establishes the trusted communication comprising a Web Real-Time Communication (WebRTC) channel.

6. The system of claim 1, wherein at least one of the first communication or the second communication comprises packetized communication compliant with Session Initiation Protocol (SIP) messages and media streaming.

7. The system of claim 1, wherein upon determining the content does not require the natural language interaction, resolving the work item by the internal resource and omitting communications with the second resource.

8. The system of claim 1, wherein the first resource comprises a fulfillment enabler, wherein the fulfillment enabler establishes the second communication with the trusted resource.

9. The system of claim 8, wherein the request for the data is received by the internal resource further comprising a fulfillment enabler and wherein the fulfillment enabler receives the request for the data from the external resource, requests the data from a data component, and provides the results received from the data component to the external resources.

10. The system of claim 1, wherein the fulfillment enabler receives the request from the external resource comprising a fulfillment enabler proxy, and provides the data to the fulfillment enabler proxy.

11. The system of claim 1, wherein the natural language interaction comprises at least one workflow decision determined from a value of the data.

12. The system of claim 1, wherein the natural language interaction with the user is required to resolve the work item, upon the processor determining that the work item is absent a request known to the internal resource and having a known resolution known to the resource.

13. A method for adaptive response to a communication, comprising:
receiving a first communication from a user device utilized by a user via a network, wherein the first communication comprises content further comprising a work item to resolve;
routing the first communication to include an internal resource to attempt to resolve the work item;
monitoring the content of the first communication between the user device and internal resource to determine whether a natural language interaction with the user is required to resolve the work item;
upon determining the content does require the natural language interaction, routing the first communication to include a second communication comprising an external resource providing natural language interactions as a portion of the content, wherein the second communication is conducted via a trusted communication channel;
receiving, via the trusted communication channel, a request for data from the external resource and responding thereto with the data, wherein in the data is required to resolve the work item; and
in response to receiving a signal from the external resource that the work item has been resolve, terminating the first communication.

14. The method of claim 13, wherein the external resource comprises a cloud provider, wherein the cloud provider comprises a plurality of computational, data storage, and communication resources dynamically allocated for use by the system to appear to the system as dedicated resources.

15. The method of claim 13, wherein the trusted communication with the external resource comprising, sending a hypertext transfer protocol secure (HTTPS) request to the cloud provider.

16. The method of claim 15, further comprising, in response to the HTTPS request, establishing the trusted communication comprising establishing a WebSocket tunnel.

17. The method of claim 15, wherein the external resource, in response to the HTTPS request, establishing the trusted communication comprising establishing a Web Real-Time Communication (WebRTC) channel.

18. The method of claim 13, wherein at least one of the first communication or the second communication comprises packetized communication compliant with Session Initiation Protocol (SIP) messages and media streaming.

19. The method of claim 13, wherein upon determining the content does not require the natural language interaction, resolving the work item by the internal resource and omitting communications with the second resource.

20. A system for adaptive response to a communication, comprising:
means to receive a first communication from a user device utilized by a user via a network, wherein the first communication comprises content further comprising a work item to resolve;
means to route the first communication to include an internal resource to attempt to resolve the work item;
means to monitor the content of the first communication between the user device and internal resource to determine whether a natural language interaction with the user is required to resolve the work item;
means to, upon determining the content does require the natural language interaction, route the first communication to include a second communication comprising an external resource providing natural language interactions as a portion of the content, wherein the second communication is conducted via a trusted communication channel;
means to receive, via the trusted communication channel, a request for data from the external resource and responding thereto with the data, wherein in the data is required to resolve the work item; and
means to, in response to receiving a signal from the external resource that the work item has been resolve, terminate the first communication.
